(19) United States
(12) Patent Application Publication
(10) Pub. No.: US 2025/0386417 A1
(43) Pub. Date: Dec. 18, 2025

(54) SYSTEMS AND METHODS FOR CONDITIONING A GAS FLOW IN A PLASMA PROCESSING SYSTEM

(71) Applicant: Hypertherm, Inc., Hanover, NH (US)

(72) Inventors: Eric Brown, Charlestown, NH (US); Ross A. Smith, Hanover, NH (US)

(21) Appl. No.: 19/220,638

(22) Filed: May 28, 2025

Related U.S. Application Data
(60) Provisional application No. 63/659,057, filed on Jun. 12, 2024.

(51) Int. Cl. H05H 1/36

(52) U.S. Cl. CPC H05H 1/36

(57) ABSTRACT

A gas supply system for a plasma cutting system is provided. The gas supply system includes a gas supply line configured to fluidly connect between a gas source and a plasma arc torch. The gas supply line is configured to receive a gas flow from the gas source for delivery to the plasma arc torch. The gas supply system also includes an oscillatory energy source disposed on the gas supply line and a gas flow sensor disposed on the gas supply line downstream of the oscillatory energy source. The gas supply system further includes a resonation chamber fluidly connected to the gas supply line between the oscillatory energy source and the gas flow sensor. The resonation chamber is configured to dampen an oscillation in the gas flow in the gas supply line.

### CROSS REFERENCE TO RELATED APPLICATION

This application claims the benefit of and priority to U.S. Provisional Patent Application No. 63/659,057 filed on Jun. 12, 2024, the entire content of which is owned by the assignee of the instant application and incorporated herein by reference in its entirety.

### TECHNICAL FIELD

The present invention generally relates to systems and methods for conditioning a gas flow supplied to a plasma processing system, such as smoothing oscillations in the gas flow.

### BACKGROUND

Plasma arc torches are widely used for high temperature processing (e.g., cutting, welding, and marking) of metallic materials. A plasma arc torch generally includes a torch body, an electrode mounted within the body, an emissive insert disposed within a bore of the electrode, a nozzle with a central exit orifice, a shield, electrical connections, passages for cooling and arc control fluids, a swirl ring to control the fluid flow patterns, and a power supply. The plasma arc torch can produce a plasma arc, which is a constricted, ionized jet of plasma gas with high temperature and high momentum. Gases used in the torch can be non-reactive (e.g., argon or nitrogen) or reactive (e.g., oxygen or air).

Plasma arc processing systems utilize and are reliant on a number of varied gas flows throughout the systems, including plasma arc torches and consumables, to generate and support plasma arc generation as well as to extend the life of system components. The complexity and overall sensitivity of various plasma arc cutting processes and their dependencies on these gas flows means that inconsistent and/or non-precisely tuned and controlled gas flows can be critical and damaging to the systems, processes and work products. For example, inconsistent cutting gas flows comprising hydrogen, argon and nitrogen supplied to a gas mixer can give rise to unpredictable and inconsistent cutting outcomes for the operator.

Some plasma arc processing systems have tried to generate consistent gas flows and cutting outcomes via one or more of perfect check valve selection, isolating shield control loop noise with internal regulators, tightly controlling inlet gas pressures on mixer inlets, slowing down mixer gas control loops, moving check valves downstream relative to flow measurement etc. However, these steps have been ineffective in terms of producing consistent gas flows and are often complex and expensive to implement. This is at least in part because the root cause of the inconsistent gas flow is oscillation in the check valves at the inlet of the gas mixer, which can cause erroneous readings in the flow meters located within the gas mixer. The oscillations in the flow, in turn, leads to inconsistent flows by the control loop.

Therefore, there is a need for systems and methods that can effectively dampen oscillation in one or more gas flows in a plasma processing system.

### SUMMARY

The present invention features usage of fluidly/dynamically connected adjacent gas volumes (e.g., resonators) that are specifically designed to combat oscillations at and/or around specific frequencies to generate a more consistent cutting outcome. This can be accomplished via a gas volume (e.g., resonator) that is T-ed into or adjacent, but connected (e.g., fluidly connected, dynamically connected, etc.), to the main gas supply line. In some embodiments, the gas volume (e.g., resonator) acts as a resonance chamber to dampen the oscillations in the gas flow in the gas supply line and is tunable to the frequency of pressure (sound) wave damping.

In one aspect, the present invention features a gas supply system for a plasma cutting system. The gas supply system comprises a gas supply line configured to fluidly connect between a gas source and a plasma arc torch. The gas supply line is configured to receive a gas flow from the gas source for delivery to the plasma arc torch. The gas supply system also includes an oscillatory energy source disposed on the gas supply line and a gas flow sensor disposed on the gas supply line downstream of the oscillatory energy source. The gas flow sensor is configured to measure a flow rate of the gas flow through the gas supply line. The gas supply system further includes a resonation chamber fluidly connected to the gas supply line between the oscillatory energy source and the gas flow sensor. The resonation chamber is configured to dampen an oscillation in the gas flow in the gas supply line.

In another aspect, the present invention features a method for conditioning a gas flow through a gas supply system of a plasma cutting system. The method comprises receiving, by a gas supply line, a gas flow from a gas source and conducting, by an oscillatory energy source disposed on the gas supply line, the gas flow therethrough. The conducting is adapted to introduce an oscillation in the gas flow in the gas supply line. The method also includes dynamically conditioning, by a volume of a secondary gas in a resonation chamber dynamically connected to the gas supply line between the oscillatory energy source and the gas flow sensor, the gas flow through the gas supply line to dampen the oscillation in the gas flow. The method further includes delivering the gas flow to a plasma arc torch downstream of the resonation chamber.

Any of the above aspects can include one or more of the following features. In some embodiments, the oscillatory energy source is a check valve configured to prevent back flow of the gas flow in the gas supply line. The check valve is adapted to introduce the oscillation in the gas flow. In some embodiments, the gas supply system further comprises a gas mixer that incorporates the gas flow sensor therein. The gas mixer configured to mix the gas flow with at least a second gas flow from a second gas source.

In some embodiments, the resonation chamber is located axially aft of the oscillatory energy source and upstream of to the gas flow sensor. In some embodiments, the resonation chamber is fluidly connected to the gas supply line at a non-parallel angle. The non-parallel angle comprises about 90 degrees such that an axial length of the resonation chamber is oriented substantially perpendicular to the gas supply line.

In some embodiments, the resonation chamber defines at least one cavity having a volume for storing an auxiliary gas. In some embodiments, the volume of the at least one cavity of the resonation chamber is between about 2 cubic inches and about 4.5 cubic inches. In some embodiments, the resonation chamber includes a plurality of cavities. In some embodiments, the dynamic conditioning by the resonation chamber comprises dissipating energy from the gas flow in the gas supply line to the volume of auxiliary gas in the resonation chamber.

In some embodiments, the gas supply system further comprises a resonator manifold configured to fluidly connect the at least one cavity of the resonation chamber to the gas supply line. The resonator manifold includes a critical orifice providing an opening to the at least one cavity. In some embodiments, a ratio of a volume of the critical orifice to a volume of the cavity is less than about 5%. In some embodiments, the resonator manifold includes a dividing membrane fluidly isolating the gas flow through the gas supply line from the auxiliary gas in the resonation chamber. In some embodiments, the resonator manifold includes a plurality of critical orifices.

In some embodiments, the critical orifice of the resonator manifold defines at least one adjustable dimension comprising a length, width, or cross-sectional area. In some embodiments, one or more dimensions of at least one of the resonation chamber or the resonator manifold is adjustable to tune a dissipation frequency of the resonation chamber to approximate one of a plurality of dominant frequencies of the gas supply system. In some embodiments, at least one of the volume of the resonation chamber, the length of the critical orifice, the width of the critical orifice or the cross-sectional area of the critical orifice is adjustable to dampen the oscillation in the gas flow in the gas supply line.

In some embodiments, the gas flow in the gas supply line is fluidly connected to the secondary gas in the resonation chamber without being fully isolating from each other. For example, less than about 5% of the gas flow in the gas supply line can enter the resonation chamber. In some embodiments, the gas flow in the gas supply line is fluidly isolated from the secondary gas in the resonation chamber by a diaphragm disposed in the orifice of the resonator manifold while the diaphragm enables dynamic transfer of energy between the gas flow and the secondary gas.

In some embodiments, a flow rate of the gas flow through the gas supply line is measured by a gas flow sensor disposed on the gas supply line downstream of the oscillatory energy source and the resonator manifold.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary gas supply system of a plasma arc processing system, according to some embodiments of the present invention.

FIG. 2 shows an exemplary connection of the resonation chamber to the resonator manifold in the gas supply system of FIG. 1, according to some embodiments of the invention.

FIG. 3 shows an exemplary energy dissipation graph for tuning at least one dimension of the resonation chamber or the resonator manifold of the gas supply system of FIG. 1, according to some embodiments of the present invention.

FIGS. 4a and 4b show exemplary measurements for a nitrogen gas flow in the gas supply line of FIG. 1 produced without and with, respectively, the gas supply line being fluidly/dynamically connected to the resonation chamber and the resonator manifold, according to some embodiments of the present invention.

FIG. 5 shows an exemplary process for conditioning a gas flow in the gas supply system of FIG. 1, according to some embodiments of the present invention.

### DETAILED DESCRIPTION

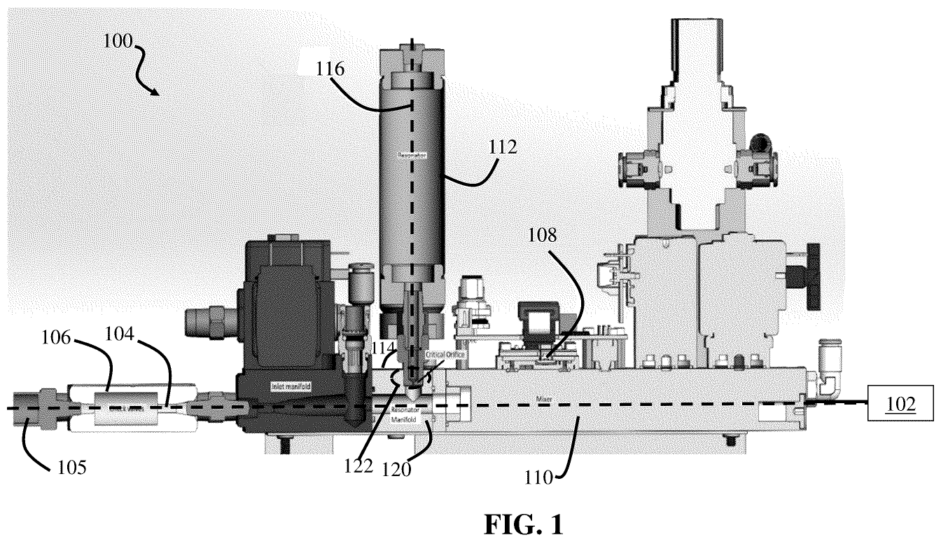

FIG. 1 shows an exemplary gas supply system 100 of a plasma arc processing system, according to some embodiments of the present invention. Typically, the gas supply system 100 is utilized in a plasma cutting system and configured to supply a gas or a mixture of several gases at the appropriate gas settings to a plasma arc torch 102 attached to the gas supply system 100. As shown, the gas supply system 100 includes a gas supply line 104 that fluidly connects a gas source 105 to the plasma arc torch 102. The gas supply line 104 is adapted to receive a gas flow from the gas source 105 for delivery to the plasma arc torch 102. An oscillatory energy source 106 is disposed on the gas supply line 104, such as on the upstream side of the gas supply line 104 adjacent to the gas source 105. The oscillatory energy source 106 can be a check valve configured to prevent backflow of the gas in the gas supply line 104; however, the oscillatory energy source 106 is also adapted to introduce an oscillation in the gas flow therethrough. In general, the oscillatory energy source 106 can be any component of the gas supply system 100 that introduces oscillation into the gas flow (e.g., communication of pressure and/or sound along the gas flow, variances in the conditions of the gas flow over time, mechanical interactions with the gas flow which affect the gas flow's consistency/conditions, etc.) to cause, for example, added oscillatory energy in the gas flow, reverberations in the gas flow, pressure waveform in the gas flow, etc., In addition, a gas flow sensor 108 is disposed on the gas supply line 104 downstream of the oscillatory energy source 106. The gas flow sensor 108 is configured to measure a flow rate of the gas flow through the gas supply line 104, such as for downstream regulation purposes. In some embodiments, the gas flow sensor 108 is located within (e.g., integrated with) a gas mixer 110 configured to mix the gas flow with at least a second gas flow from a second gas source (not shown).

In some embodiments, to dampen the oscillation in the gas flow in the gas supply line 104, a resonation chamber 112 is fluidly/dynamically connected to the gas supply line 104 between the oscillatory energy source 106 and the gas flow sensor 108. For example, the resonation chamber 112 can be located downstream of the oscillatory energy source 106 and upstream of to the gas flow sensor 108. In some embodiments, the resonation chamber 112 is fluidly/dynamically connected to the gas supply line 104 at a non-parallel angle 114 relative to the gas supply line 104 to optimize the effectiveness of oscillation dampening (e.g., dissipate pressure waveforms) in the gas flow and ensure more accurate gas flow readings by the gas flow sensor 108. The non-parallel angle 114 can be about 90 degrees such that an axial length 116 of the resonation chamber 112 is oriented substantially perpendicular to the gas supply line 104.

In some embodiments, the resonation chamber 112 defines at least one cavity that stores a volume of auxiliary gas, which can be distinct from the gas in the gas supply line 104. In this context, “fluid connection” or “dynamic connection” between the resonation chamber 112 and the gas supply line 104 is defined as permitting communication and/or exchange of pressure waveforms/energy between the gases in the two components without physically mixing the gases. During operation, the gas volume in the resonation chamber 112 conditions the gas flow in the gas supply line 104 in such a manner (e.g., via resonance modulation) that once the gas flow axially travels past the resonation chamber 112, oscillation in the gas flow is smoothened, which facilitates measurement of the resulting gas flow rate (e.g., consistent and accurate measurement) by the downstream gas flow sensor 108 and encourages repeatability of mass flow measurements of the gas flow.

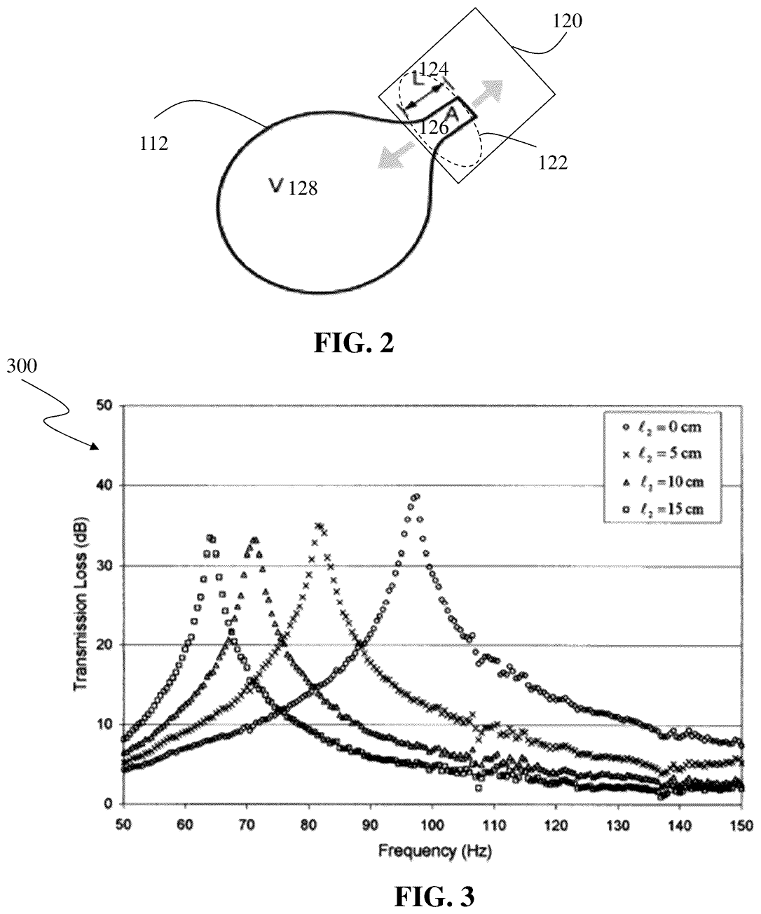

In some embodiments, the gas supply system 100 additionally includes a resonator manifold 120 having a critical orifice 122 configured to fluidly/dynamically connect the at least one cavity of the off-path resonation chamber 112 with the main gas flow path defined by the gas flow supply line 104. In one exemplary implementation, the resonation chamber 112 can be in the form of a commercially available gas cylinder, and the cylinder can be connected to the resonator manifold 120 with fitting(s) that act as the critical orifice 122. FIG. 2 shows an exemplary connection of the resonation chamber 112 to the resonator manifold 120 via a critical orifice 122 of the resonator manifold 120, according to some embodiments of the invention. The critical orifice 122 of the resonator manifold 120 provides an opening to the at least one cavity of the resonator chamber 112 to allow the auxiliary gas volume in the cavity 112 to modulate the gas flow in the main gas supply line 104 in a controlled manner. As shown, the critical orifice 122 defines at least one adjustable dimension, such as length 124, width (not shown), or cross-sectional area 126, for optimizing the dampening effect of the auxiliary gas volume on the oscillation of the gas flow. In addition, in some embodiments, the auxiliary gas volume 128 of the resonator chamber 112 itself is adjustable to optimize and or improve the damping/dampening effect. Thus, at least one dimension of the resonator manifold 120 (e.g. the length 124, width, cross-sectional area 126 of the critical orifice 122) or the resonation chamber 112 (e.g., the gas volume 128 of the cavity) is adjustable/designable to achieve a desired dissipation effect on the oscillation of the gas flow in the gas supply line 104.

In alternative embodiments, the resonation chamber 112 includes more than one cavity and the resonator manifold 120 includes more than one critical orifice assigned to respective ones of the multiple cavities. The multiple cavities and/or multiple critical orifices can be selectively accessible either individually or collaboratively to adjust and tune the gas supply system 100 for various processes and gases and their associated distinct resonance frequencies.

In some embodiments, the resonator manifold 120 includes a dividing membrane (not shown) fluidly isolating the main gas flow through the gas supply line 104 from the auxiliary gas in the resonation chamber 112 (i.e., prevent mixing of the gases) while permitting dynamic communication between the gases (i.e., permitting transfer of energy and/or communication of pressure waveforms between the gases via resonance modulation). Thus, the dividing membrane is configured to enable the “fluid connection” or “dynamic connection” between the resonation chamber 112 and the gas supply line 104 as described above, while maintaining the gases as chemically distinct/unmixed. In some embodiments, resonation chamber 112 includes a gas that is chemically distinct from the gas flow through gas supply line 104 and has a different density and/or molecular weight than the gas flow through gas supply line 104. In general, this gas in resonation chamber 112 can be selected to tune the oscillations in gas supply line 104.

In some embodiments, the desired dissipation effect asserted by the resonation chamber 112 and/or the resonator manifold 120 is realized by adjusting one or more of the dimensions of these components to achieve a ratio of the volume of the critical orifice 122 in the resonator manifold 120 to the volume of the cavity in resonation chamber 112 to be less than about 5%. For example, the volume of a cavity of the resonation chamber 112 can be set to between about 2 cubic inches and about 4.5 cubic inches. The diameter of the critical orifice 122 can be set to between about 0.010 inches to about 0.3 inches. In some embodiments, the resonation chamber 112 and/or the resonator manifold 120 form a Helmholtz resonator. The desired dissipation effect for this type of resonator is realized by adjusting one or more of the dimensions of thee resonator components to achieve a desired resonance frequency (f_{resonance}) that approximates one of multiple dominant frequencies of the gas supply system 100. More specifically, this desired resonance frequency (f_{resonance}) can be achieved in accordance with the following Helmholtz equation:

$${f}_{resonance} = \frac{v}{2 π} \sqrt{\frac{A}{VL}}$$

Where v is the speed of sound in the auxiliary gas in cavity of the resonator chamber 112, V is the volume of the cavity in the resonator chamber 112, A is the cross-sectional area 126 of the critical orifice 122 and L is the length 124 of the critical orifice 122.

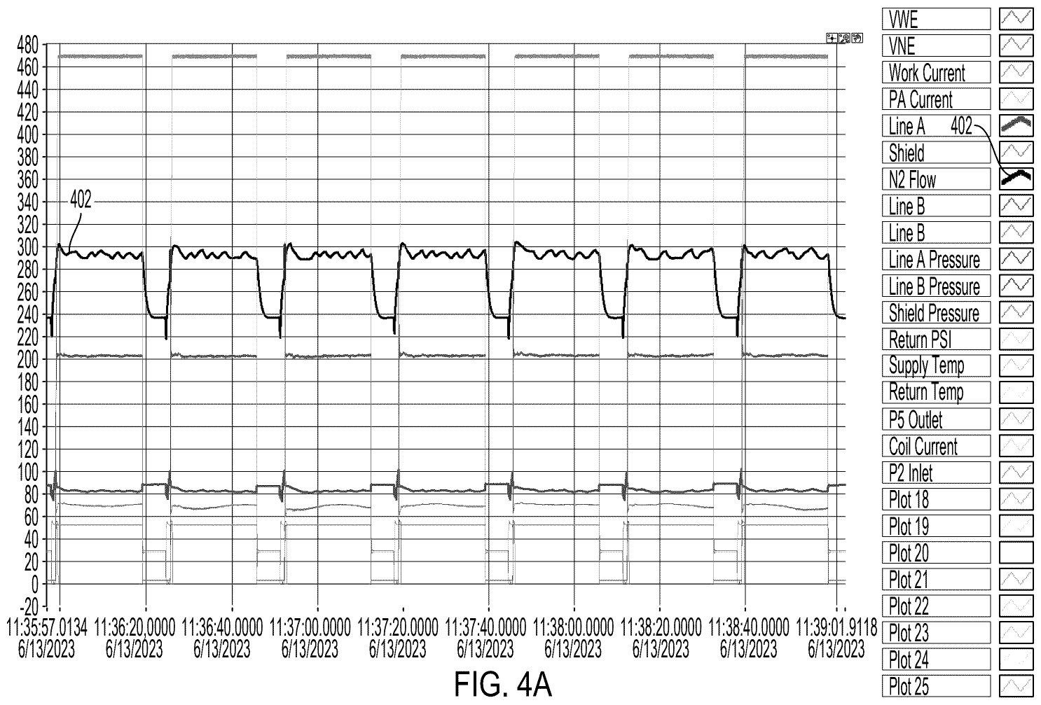

FIG. 3 shows an exemplary energy dissipation graph 300 for tuning at least one dimension of the resonation chamber 112 or the resonator manifold 120 of the gas supply system 100 of FIG. 1, according to some embodiments of the present invention. Graph 300 shows the amount of amplitude dissipation achieved by varying the lengths of resonator main volume (e.g., ranging from 0 cm to 15 cm as shown in FIG. 3). Applying this principle to the gas supply system 100 of FIGS. 1 and 2, the length of the critical orifice L 124 (thus the length of the resonator volume) can be adjusted to achieve the desired amplitude dissipation effect, while holding all other variables of the resonator structure constant (i.e., critical orifice cross-sectional area A 126, cavity volume v 128, and speed of sound in the gas type v).

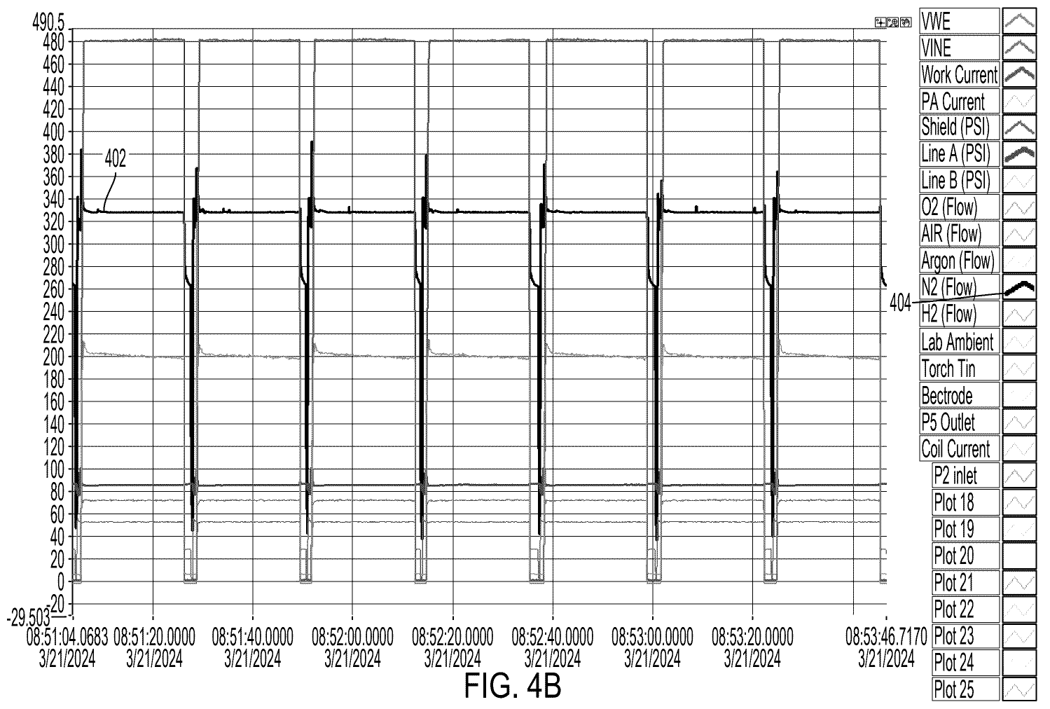

FIGS. 4a and 4b show exemplary measurements of a nitrogen gas flow in the gas supply line 104 of FIG. 1 produced without and with, respectively, the gas supply line 104 being fluidly/dynamically connected to the resonation chamber 112 and the resonator manifold 120, according to some embodiments of the present invention. As shown in FIG. 4a, reverberations and pressure oscillations in the measured nitrogen gas flow, particularly in the nitrogen flow rate measurement 402, are persistent and present throughout the gas supply system 100 and are likely to impact plasma cutting outcomes. In contrast, as shown in FIG. 4b, reverberations and pressure oscillations are not persistent nor present in the system 100, including in the nitrogen flow rate measurement 404. Thus, they do not impact cut outcomes as much as the reverberating and oscillating nitrogen gas flow of FIG. 4a.

Table 1 below shows comparative examples of benchtop testing results (e.g., mock cuts) produced without and with, respectively, the gas supply line 104 being fluidly/dynamically connected to the resonation chamber 112 and the resonator manifold 120. In particular, Table 1 shows the number of bad gas flows (i.e. gas flows with oscillations exceeding an acceptable threshold) during test cuts without resonators, with resonators, and with resonators with 0.020-inch orifices.

TABLE 1

| Crack pressure of | No | | Resonators with |
|---|---|---|---|
| check valve tested | resonator | Resonators | .020″ orifice |
| | Oscillating cuts | | |
| 5 psi | 8 out of | 0 out of | 41 out of |
| (Stronger spring) | 180 cuts | 270 cuts | 300 cuts |
| 1 psi | 0 out of | 0 out of | 0 out of |
| (weaker spring) | 210 cuts | 500 cuts | 270 cuts |
| | Oscillating % of cuts tested | | |
| 5 psi | 4.44% | 0.00% | 13.67% |
| (Stronger spring) | | | |
| 1 psi | 0.00% | 0.00% | 0.00% |
| (weaker spring) | | | |

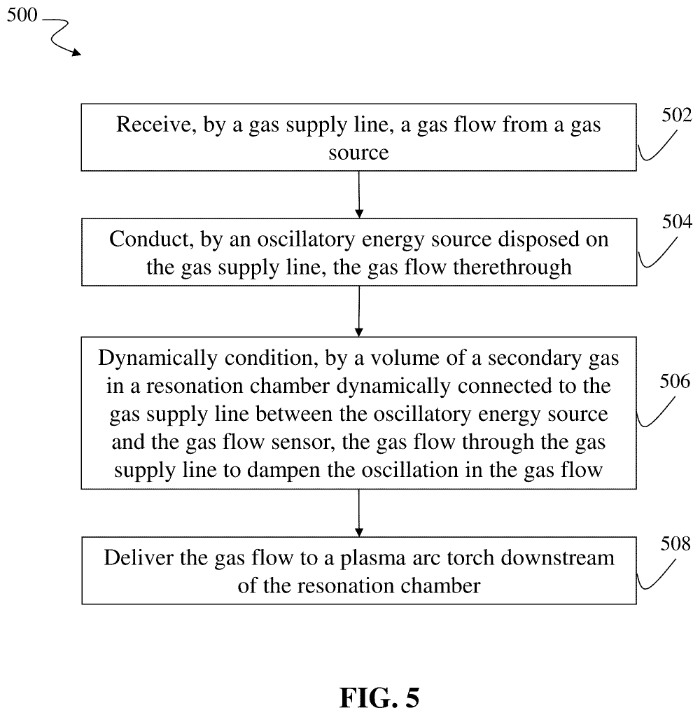

FIG. 5 shows an exemplary process for conditioning a gas flow in the gas supply system 100 of FIG. 1, according to some embodiments of the present invention. The process starts at step 502 with the gas supply line 104 receiving from the gas source 105 a flow of a gas for delivery to the plasma arc torch 102 connected to the gas supply system 100. At step 504, while the gas supply line 104 conducts the gas flow to the plasma arc torch 102, an oscillatory energy source 106 (e.g., a check valve) coupled to the flow path on the gas supply line 104 can introduce oscillation to the gas flow, thereby giving rise to unpredictable and inconsistent cutting outcomes by the torch 102.

At step 506, a volume of a secondary gas in a resonation chamber 112 is fluidly/dynamically connected to the gas supply line 104 between the oscillatory energy source 106 and the gas flow sensor 108. This volume of secondary gas is adapted to condition the gas flow through the gas supply line 104 by dissipating energy from the gas flow to the secondary gas, thus reducing the oscillation in the gas flow. In some embodiments, the fluid/dynamic connection between the resonation chamber 112 and the gas supply line 104 prevents substantial exchanging/intermingling of the gas flow in the gas supply line 104 and the secondary gas in the resonation chamber 112 while supporting transfer of energy between the gases (i.e., without fully isolating the gases from each other). In some embodiments, about less than about 5% of the gas flow in the gas supply line 104 enters the resonation chamber 112 or vice versa.

In some embodiments, the resonation chamber 112 is fluidly/dynamically connected to the gas supply line 104 via an adjustable critical orifice 122 in the resonator manifold 120. In some embodiments, the gas supply line 104 is oriented at a non-parallel angle 114 relative to the axial length of the critical orifice 122 in the resonator manifold 120 and/or the axial length 116 of the resonation chamber 112. In some embodiments, the fluid/dynamic connection between the gas flow in the gas supply line 104 and the secondary gas in the resonation chamber 112 is accomplished by disposing a diaphragm in the critical orifice 122.

In some embodiments, one or more of the volume 128 of the cavity of the resonation chamber 112, the length 124 of the critical orifice 122 in the resonator manifold 120, the width of the critical orifice 122, or the cross-sectional area 126 of the critical orifice 122 is adjustable (e.g., via adjustment of the installed component, selective replacement of the component with one with the desired dimensions/characteristics, etc.) to tune the oscillation dissipation. For example, one or more of these dimensions is adjustable to tune a dissipation frequency to match a dominant frequency of the system 100.

At step 508, the conditioned gas flow is delivered by the gas supply line 104 to the plasma arc torch 102 located downstream of the resonation chamber 112. In some embodiments, the flow sensor 108, which is disposed on the gas supply line 104 downstream of the oscillatory energy source 106 and the resonator manifold 120, such as integrated with the gas mixer 110, is configured to measure the flow rate of the gas flow through the gas supply line 104.

It is understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A gas supply system for a plasma cutting system, the gas supply system comprising:
a gas supply line configured to fluidly connect between a gas source and a plasma arc torch, the gas supply line configured to receive a gas flow from the gas source for delivery to the plasma arc torch;
an oscillatory energy source disposed on the gas supply line;
a gas flow sensor disposed on the gas supply line downstream of the oscillatory energy source, the gas flow sensor configured to measure a flow rate of the gas flow through the gas supply line; and
a resonation chamber fluidly connected to the gas supply line between the oscillatory energy source and the gas flow sensor, the resonation chamber configured to dampen an oscillation in the gas flow in the gas supply line.

2. The gas supply system of claim 1, wherein the oscillatory energy source is a check valve configured to prevent back flow of the gas flow in the gas supply line, wherein the check valve is adapted to introduce the oscillation in the gas flow.

3. The gas supply system of claim 1, wherein the resonation chamber is located axially aft of the oscillatory energy source and upstream of to the gas flow sensor.

4. The gas supply system of claim 1, further comprising a gas mixer that incorporates the gas flow sensor therein, the gas mixer configured to mix the gas flow with at least a second gas flow from a second gas source.

5. The gas supply system of claim 1, wherein the resonation chamber is fluidly connected to the gas supply line at a non-parallel angle.

6. The gas supply system of claim 5, wherein the non-parallel angle comprises about 90 degrees such that an axial length of the resonation chamber is oriented substantially perpendicular to the gas supply line.

7. The gas supply system of claim 1, wherein the resonation chamber defines at least one cavity having a volume for storing an auxiliary gas.

8. The gas supply system of claim 7, further comprising a resonator manifold configured to fluidly connect the at least one cavity of the resonation chamber to the gas supply line, the resonator manifold including a critical orifice providing an opening to the at least one cavity, wherein the critical orifice defines at least one adjustable dimension comprising a length, width, or cross-sectional area.

9. The gas supply system of claim 8, wherein at least one of the resonation chamber or the resonator manifold is adjustable to tune a dissipation frequency of the resonation chamber to approximate one of a plurality of dominant frequencies of the gas supply system.

10. The gas supply system of claim 8, wherein at least one of the volume of the resonation chamber, the length of the critical orifice, the width of the critical orifice or the cross-sectional area of the critical orifice is adjustable to dampen the oscillation in the gas flow in the gas supply line.

11. The gas supply system of claim 7, wherein the resonation chamber includes a plurality of cavities.

12. The gas supply system of claim 8, wherein the resonator manifold includes a plurality of critical orifices.

13. The gas supply system of claim 8, wherein the resonator manifold includes a dividing membrane fluidly isolating the gas flow through the gas supply line from the auxiliary gas in the resonation chamber.

14. The gas supply system of claim 7, wherein the volume of the at least one cavity of the resonation chamber is between about 2 cubic inches and about 4.5 cubic inches.

15. A method for conditioning a gas flow through a gas supply system of a plasma cutting system, the method comprising:
receiving, by a gas supply line, a gas flow from a gas source;
conducting, by an oscillatory energy source disposed on the gas supply line, the gas flow therethrough, wherein the conducting is adapted to introduce an oscillation in the gas flow in the gas supply line;
dynamically conditioning, by a volume of a secondary gas in a resonation chamber dynamically connected to the gas supply line between the oscillatory energy source and the gas flow sensor, the gas flow through the gas supply line to dampen the oscillation in the gas flow; and
delivering the gas flow to a plasma arc torch downstream of the resonation chamber.

16. The method of claim 15, wherein the dynamic conditioning comprises supporting a fluid connection between the gas flow in the gas supply line and the secondary gas in the resonation chamber without fully isolating them from each other.

17. The method of claim 16, wherein less than about 5% of the gas flow in the gas supply line enters the resonation chamber.

18. The method of claim 15, wherein the resonation chamber is dynamically connected to the gas supply line via an orifice in a resonator manifold.

19. The method of claim 18, wherein the gas supply line is oriented at a non-parallel angle relative to an axial length of the orifice in the resonator manifold.

20. The method of claim 18, further comprising fluidly isolating the gas flow in the gas supply line and the volume of the secondary gas in the resonation chamber from one another by a diaphragm disposed in the orifice while enabling dynamic transfer of energy between the gas flow and the secondary gas.

21. The method of claim 18, further comprising measuring a flow rate of the gas flow through the gas supply line by a gas flow sensor disposed on the gas supply line downstream of the oscillatory energy source and the resonator manifold.

22. The method of claim 18, wherein the dynamic conditioning by the resonation chamber comprises dissipating energy from the gas flow to the volume of secondary gas.

23. The method of claim 22, further comprising adjusting one or more of a volume of the resonation chamber, a length of the orifice in the resonator manifold, a width of the orifice, or a cross-sectional area of the orifice to tune the dissipation.

24. The method of claim 22, further comprising tuning a dissipation frequency to match a dominant frequency of the plasma processing system by adjusting one or more dimensions of at least one of the resonation chamber or the resonator manifold.
